(19) United States
(12) Patent Application Publication
(10) Pub. No.: US 2010/0080097 A1
(43) Pub. Date: Apr. 1, 2010

(54) Medium Processor and Medium Processing Method

(75) Inventor: Midori Nakamae, Tokyo (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/481,309

(22) Filed: Jun. 9, 2009

(30) Foreign Application Priority Data
Sep. 30, 2008 (JP) 2008-254504

(51) Int. Cl. G11B 20/00

(52) U.S. Cl. 369/47.15; G9B/20

(57) ABSTRACT

According to one embodiment, a medium processor includes a detector, an acquiring module, a storage module, and an output module. The detector detects a data storage medium. The acquiring module acquires a use period that is set as a period during which data recorded on the data storage medium is supposed to be intact. The storage module stores identification information that identifies the data storage medium in association with the use period. The output module outputs the identification information and the use period stored in the storage module in association with each other.

### CROSS-REFERENCE TO RELATED APPLICATIONS

This application is based upon and claims the benefit of priority from Japanese Patent Application No. 2008-254504, filed Sep. 30, 2008, the entire contents of which are incorporated herein by reference.

### BACKGROUND

1. Field

One embodiment of the invention relates to a medium processor and a medium processing method for managing the service life of a data storage medium.

2. Description of the Related Art

In recent years, players for recording and reproducing moving images and sound have been developed that use a removable data storage medium such as an optical disc. Typical examples of the optical disc include DVD-RAM and DVD±RW. The data storage medium is removably mountable, and records and stores various data. Increased number of users construct a library using a plurality of storage media.

There are various types of data storage media in addition to the optical disc. As examples of the data storage media may be cited a magnetic disk such as a hard disk and a semiconductor memory such as EEPROM. Data is magnetically written and read on the magnetic disk, while data is electrically written and read on the semiconductor memory.

Such a data storage medium is basically capable of storing data for a long period of time. However, the data storage medium deteriorates as time elapses, and it may unfortunately happen that data recorded on the data storage medium cannot be reproduced by a player and cannot be recovered therefrom.

To avoid such an event that data recorded on the data storage medium cannot be recovered, it has been proposed to provide HDD with a function of predicting hard drive failures (Self Monitoring, Analysis and Report Technology: S.M.A.R.T.). For example, Japanese Patent Application Publication (KOKAI) No. 2007-213670 discloses a conventional technology which encourages users to create a backup copy of data stored in HDD using the failure prediction or S.M.A.R.T. function of the HDD. Thus, even if the information technology is unfamiliar to the users, the data can be prevented from being lost forever.

With the above conventional technology, a user is warned based on S.M.A.R.T. information from the HDD. In other words, while it is possible to detect the failure of the installed HDD, it is not possible to detect the failure of a removable data storage medium.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of an information processor according to a first embodiment of the invention;

FIG. 2 is an exemplary schematic diagram of the data structure of an service life management table in the first embodiment;

FIG. 3 is an exemplary schematic diagram of information printed by a label printer on the label of a data storage medium in the first embodiment;

FIG. 4 is an exemplary schematic diagram of the service life management table to which a new entry is added by a register in the first embodiment;

FIG. 5 is an exemplary schematic diagram of the service life management table updated by an update module based on a change in read/write error rate in the first embodiment;

FIG. 6 is an exemplary schematic diagram of a screen displayed on a display device based on information output form an output processor in the first embodiment;

FIG. 7 is an exemplary schematic diagram of a screen displayed on the display device based on information output form the output processor after the update module updates the service life management table in the first embodiment;

FIG. 8 is an exemplary schematic diagram of the service life management table updated by the update module based on a change in humidity in the first embodiment;

FIG. 9 is an exemplary schematic diagram of a screen displayed on the display device based on information output form the output processor after the update module updates the service life management table as illustrated in FIG. 8 in the first embodiment;

FIG. 10 is an exemplary schematic diagram of the service life management table after the update module deletes the entry with management No. 1 in the first embodiment;

FIG. 11 is an exemplary flowchart of the operation of the information processor in the first embodiment;

FIG. 12 is an exemplary flowchart of a service life management process illustrated in FIG. 11 performed by the information processor in the first embodiment;

FIG. 13 is an exemplary flowchart of a process of updating the expected end of service life of each data storage medium according to the surrounding environment performed by the information processor in the first embodiment; and

FIG. 14 is an exemplary schematic diagram of a screen displayed on the display device based on information output form the output processor when the expected end of service life is before the creation date according to a second embodiment of the invention.

### DETAILED DESCRIPTION

Various embodiments according to the invention will be described hereinafter with reference to the accompanying drawings. In general, according to one embodiment of the invention, a medium processor comprises a detector, an acquiring module, a storage module, and an output module. The detector is configured to detect a data storage medium. The acquiring module is configured to acquire a use period that is set as a period during which data recorded on the data storage medium is supposed to be intact. The storage module is configured to store identification information that identifies the data storage medium in association with the use period. The output module is configured to output the identification information and the use period stored in the storage module in association with each other.

According to another embodiment of the invention, a medium processing method comprises: a detector detecting a data storage medium; an acquiring module acquiring a use period that is set as a period during which data recorded on the data storage medium is supposed to be intact; storing identification information that identifies the data storage medium in association with the use period in a storage module; and an output module outputting the identification information and the use period stored in the storage module in association with each other.

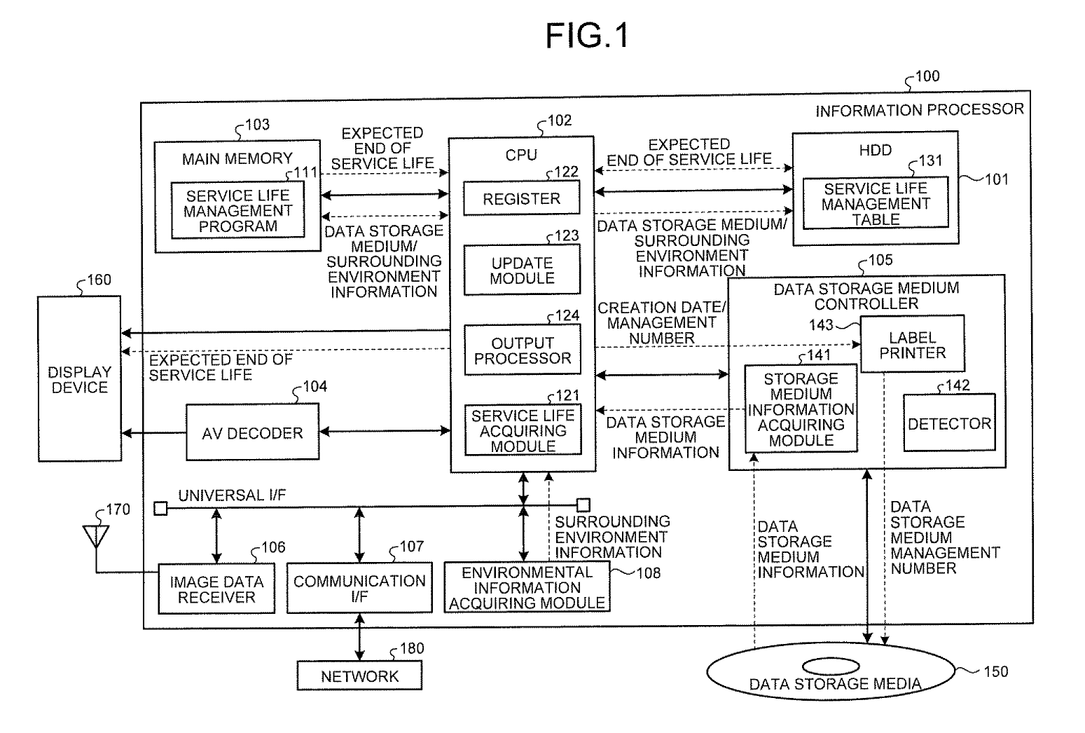

Although the medium processor of the embodiments is described below as being applied to an information processor, it can be applied to any device that performs such processes as reading data from a data storage medium. FIG. 1 is a block diagram of an information processor 100 according to a first embodiment of the invention. As illustrated in FIG. 1, the information processor 100 comprises a hard disk drive (HDD) 101, a central processing unit (CPU) 102, a main memory 103, an AV decoder 104, a data storage medium controller 105, an image data receiver 106, a communication interface (I/F) 107, and an environmental information acquiring module 108.

The information processor 100 is connected to a display device 160. The display device 160 displays information output from the information processor 100. More specifically, for example, the display device 160 displays image data including video data and text data. The display device 160 also outputs audio data in addition to the image data.

The image data receiver 106 is connected to an image information receiving antenna 170. The image information receiving antenna 170 converts radio waves into image data, and the image data receiver 106 receives the image data. The image data receiver 106 may receive, for example, a digital broadcast television (TV) program as the image data. More specifically, the image data receiver 106 receives image data corresponding to a channel specified by a command from a TV reproduction program. The image data receiver 106 demodulates the image data (broadcast data) to generate MPEG2-TS packets, and writes the packets to the main memory 103 or the HDD 101.

The HDD 101 stores OS and various programs that the information processor 100 uses to operate. The HDD 101 of the first embodiment stores in advance an service life management table 131 as one of the programs. The HDD 101 also stores received video data and the like. The service life management table 131 need not necessarily be stored in the HDD 101, but may be stored in any other commonly used storage medium such as an optical disc, a memory card, and a random access memory (RAM).

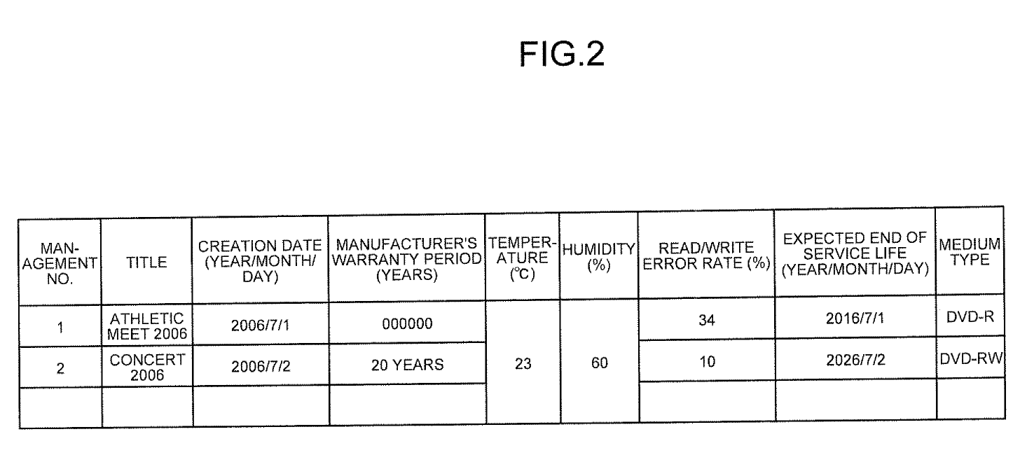

The service life management table 131 stores information on the end of service life of each of data storage media 150. FIG. 2 is a schematic diagram of the data structure of the service life management table 131. As illustrated in FIG. 2, the service life management table 131 contains items of information such as management No., title, creation date (year/month/day), manufacturer's warranty period (years), temperature (° C.), humidity (%), read/write error rate (%), expected end of service life (year/month/day), and medium type. These items are stored in association with one another.

The management No. is a number uniquely assigned to each of the data storage media 150. The title indicates the title of data recorded on each of the data storage media 150. The creation date indicates the day (year/month/day) when data is written to each of the data storage media 150 for the first time.

The manufacturer's warranty period is a period during which the manufacturer of each of the data storage media 150 is responsible for the data storage medium 150 covered under its expressed warranty. While the manufacturer' s warranty period is described below as being acquired via a network 180, it may be acquired in any manner.

The temperature (° C.) and the humidity (%) are information on the surrounding environment (environmental information) obtained by the environmental information acquiring module 108. In the first embodiment, the end of service life is predicted based on the environmental information including the temperature (° C.) and the humidity (%), and the read/write error rate (%), which will be described later, this is by way of example only. The environmental information may includes other items and such items may also be used to predict the end of service life of each of the data storage media 150.

The read/write error rate (%) is information on the rate of occurrence of errors while each of the data storage media 150 is read and written, and is the obtained by a storage medium information acquiring module 141.

The expected end of service life is set as the date until which data recorded on each of the data storage media 150 is intact and can be read. The expected end of service life is updated based on the information on the surrounding environment that deteriorates the data storage media 150.

The medium type refers to the type of each of the data storage media 150. In the first embodiment, optical media such as DVD-R and DVD-RW are cited as examples of the types of the data storage media 150. However, the data storage media 150 are not limited to the optical media, and may be of any type, such as magnetic media and silicon disks, as long as it is removably connectable to the information processor 100.

Referring back to FIG. 1, the main memory 103 provides a work area to the CPU 102. When the information processor 100 is activated, the CPU 102 loads a computer program (hereinafter, “service life management program”) 111 into the main memory 103. The service life management program 111 is previously installed on the information processor 100.

The AV decoder 104 reads image data stored in the main memory 103 through the CPU 102 to decode it, and then outputs the resultant data to the display device 160 as video data and audio data.

The communication I/F 107 is an interface to the external network 180, and communicates information with a communication device connected via the network 180. The connection to the network 180 that the communication I/F 107 provides enables the acquisition of the manufacturer's warranty period offered by the manufacturer.

The environmental information acquiring module 108 acquires information on the surrounding environment that affects the service life of the data storage media 150. In the first embodiment, the temperature and humidity are obtained as the environmental information, and thus the environmental information acquiring module 108 comprises a built-in sensor to measure the temperature and humidity around the information processor 100. Although the environmental information acquiring module 108 of the first embodiment acquires the environmental information with the sensor, it may acquire the environmental information from other sources such as weather forecast services provided via the network 180.

The environmental information acquiring module 108 of the first embodiment further comprises a built-in timer. When in standby mode, the information processor 100 is automatically woken up with this timer so that the environmental information acquiring module 108 can measure the temperature and humidity, for example, once a week at the same time on the same day of each week. According to the measurement results, an update module 123 of the CPU 102, which will be described later, updates information such as temperature and humidity stored in the service life management table 131 in the HDD 101. Incidentally, the information processor 100 need not necessarily be automatically woken up once a week with the timer. The wake-up cycle may be arbitrarily set.

The data storage medium controller 105 comprises the storage medium information acquiring module 141, a detector 142, and a label printer 193. The data storage medium controller 105 controls the data storage media 150 connected to the information processor 100. For example, the data storage medium controller 105 controls the acquisition (reading) of data from and the output (writing) of data to the data storage media 150.

The detector 142 detects whether each of the data storage media 150 is connected to the information processor 100. Having detected that one of the data storage media 150 is connected to the information processor 100, the detector 142 notifies the CPU 102 of this event. Further, the detector 142 detects whether it is the first time the data storage medium 150 has been connected to the information processor 100. The detector 142 makes this determination based on whether data is recorded on the header and storage area of the data storage medium 150 or the like. To make an accurate determination as to whether it is the first time the data storage medium 150 has been connected to the information processor 100, a management number or the like may be written to the header of the data storage medium 150 when it is connected first time to the information processor 100. The detector 142 also notifies the CPU 102 whether it is the first time the data storage medium 150 has been connected to the information processor 100.

When the detector 142 detects one of the data storage media 150 is connected first time to the information processor 100, the label printer 143 prints identification information that identifies the data storage medium 150 thereon. In the first embodiment, the label printer 143 prints the creation date and a management number as the identification information. The creation date corresponds to the “creation date” stored in the service life management table 131 and refers to the date on which data is written to the data storage medium 150 for the first time. In other words, the creation date is printing date on which the label printer 143 makes a print. The management number printed on the data storage medium 150 is a number uniquely assigned thereto.

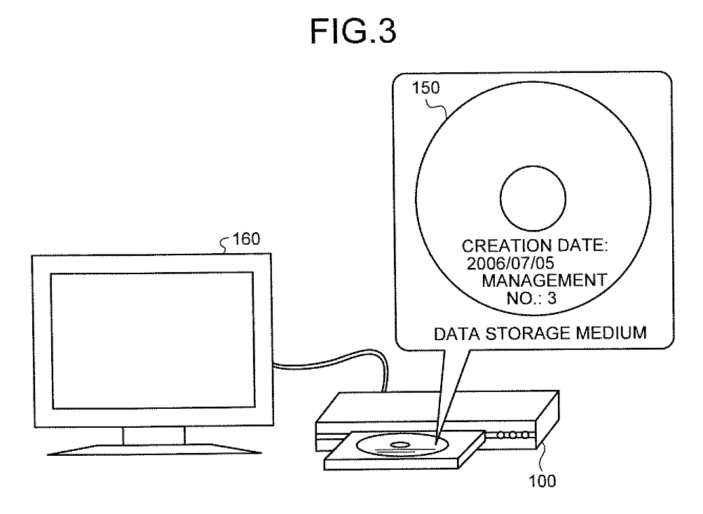

FIG. 3 illustrates an example of the identification information printed by the label printer 143 on the label of the data storage medium 150. As illustrated in FIG. 3, creation date “2006/07/05” and management No. “3” are printed on the label of the data storage medium 150.

Referring back to FIG. 1, the storage medium information acquiring module 141 acquires (reads) data from the data storage medium 150 connected to the information processor 100. The storage medium information acquiring module 141 may also write data to the data storage medium 150.

In addition, the storage medium information acquiring module 141 acquires information (state information) on the state or condition of the data storage medium 150 connected to the information processor 100. Examples of the state information include the rate of occurrence of errors during reading or writing, such as parity inner (PI) error that occurs when data on the data storage medium 150 is reproduced. The storage medium information acquiring module 141 then notifies the CPU 102 of the rate of occurrence of errors while the data storage medium 150 is read and written. With this, the CPU 102 can assess the state of the data storage medium 150.

The CPU 102 controls the information processor 100. More specifically, the CPU 102 loads the OS and the various programs from the HDD 101 into the main memory 103, and execute them.

The CPU 102 comprises built-in controllers. The controllers include a memory controller for controlling access to the main memory 103, a display controller for controlling the AV decoder 104, a controller for controlling the data storage medium controller 105, a controller for controlling the HDD 101, and a controller for controlling a universal I/F. These controllers enable the CPU 102 to control each device as well as to receive and output information.

The CPU 102 and the AV decoder 104 are connected to the display device 160. The CPU 102 and the AV decoder 104 output display information so that the display device 160 displays the display information.

The CPU 102 also loads the service life management program 111 into the main memory 103 and executes it. The service life management program 111 comprises modules including a write module, an update module, an output processing module, and a service life acquiring module. The execution of the service life management program 111 implements functional modules, such as a register 122, the update module 123, an output processor 124, and a service life acquiring module 121, in the CPU 102.

The service life acquiring module 121 acquires the service life which is previously set as the usable life of each of the data storage media 150 detected by the data storage medium controller 105. The service life acquiring module 121 of the first embodiment acquires, as the service life of each of the data storage media 150, the “manufacturer's warranty period (years)” offered by the manufacturer on the network 180 through the communication I/F 107. If the manufacturer's warranty period is not available on the network 180, the service life acquiring module 121 acquires a default value preset for each of the types of the data storage media 150. It is assumed herein that the default value for DVD-R is set to “000000” indicating a service life of 10 years.

When the detector 142 of the data storage medium controller 105 detects that a new data storage medium is connected to the information processor 100, the register 122 makes an entry of the data storage medium in the service life management table 131.

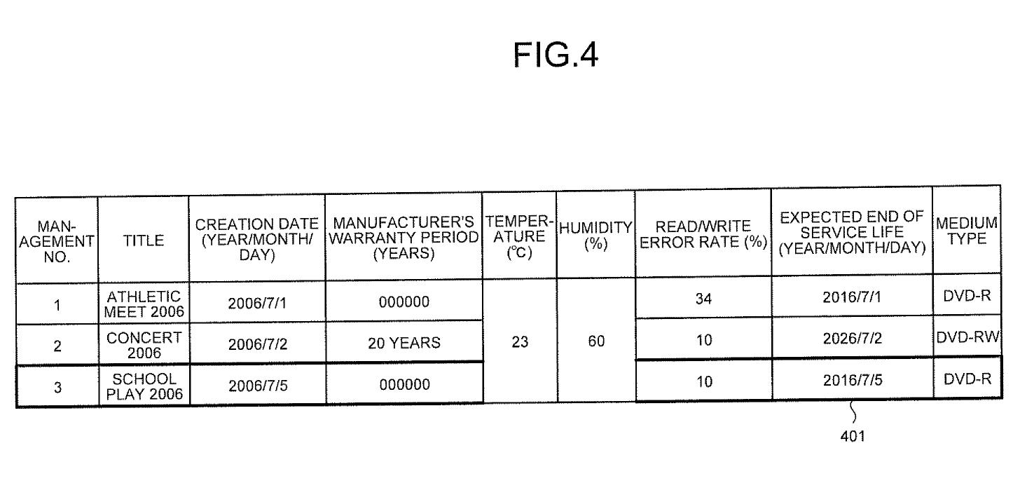

FIG. 4 illustrates an example of the service life management table 131 to which a new entry is added by the register 122. As illustrated in FIG. 4, the register 122 has registered an entry 401 with management No. “3”. The date (year/month/day) on which the entry 401 is registered is set as the creation date. The manufacturer's warranty period needs to be obtained before the register 122 makes the registration. For example, if the manufacturer offers a warranty period of 10 years for the data storage medium, the register 122 sets the manufacturer' s warranty period to 10 years. Besides, the register 122 sets the date after 10 years from the creation date as the expected end of service life. In this manner, the register 122 stores the information items in association with one another.

Referring back to FIG. 1, the update module 123 updates the service life management table 131 in the HDD 101 based on, for example, the environmental information obtained by the environmental information acquiring module 108. Further, the update module 123 calculates the expected end of service life for each of the data storage media 150 based on the environmental information obtained by the environmental information acquiring module 108. Thus, the update module 123 updates the expected end of service life in the service life management table 131.

In the first embodiment, the expected end of service life is derived by the following algorithm:

expected end of service life=creation date+manufacturer's warranty period (“000000” indicates 10 years)−1 year for each 1° C. rise of temperature from 28° C.−1 year for each 5% increase in humidity from 80%−1 year for each 10% increase in read/write error rate from 40%

As can be seen, the threshold temperature is “28° C.”, the threshold humidity is “80%”, and the threshold read/write error rate is “40%”. If there is a change in the expected end of service life based on the temperature, humidity, and read/write error rate, the update module 123 updates the service life management table 131.

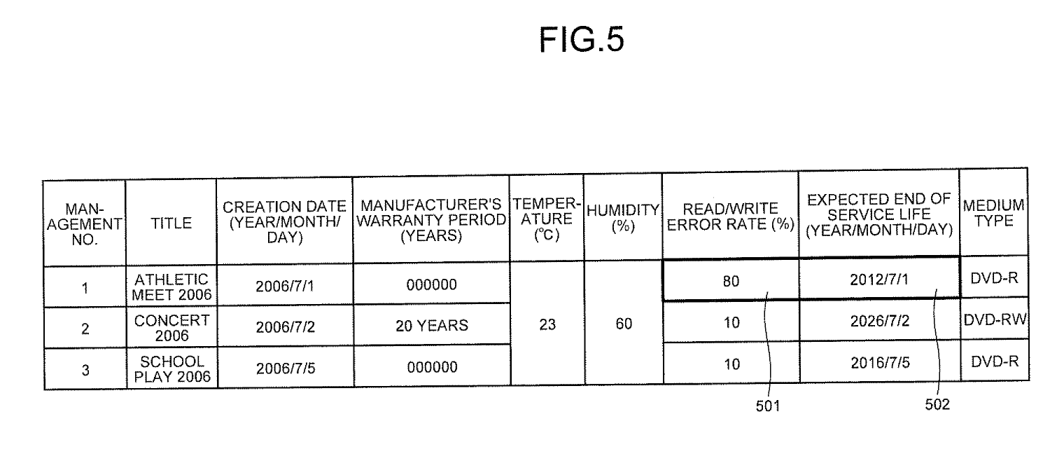

FIG. 5 illustrates an example of the service life management table 131 updated by the update module 123 based on a change in the read/write error rate. In the example of FIG. 5, the update module 123 is notified by the storage medium information acquiring module 141 of a read/write error rate of 80% for the data storage medium 150 assigned management No. “1”. Referring to the above algorithm, it is defined that “minus one year for each 10% increase in read/write error rate from 40%”. Accordingly, the update module 123 updates a field 501 with “80%”. At the same time, the update module 123 subtracts four years from the expected end of service life, i.e., “2016/7/1”, already set for management No. “1” (see FIG. 4) and updates a field 502 with “2012/7/1” thus obtained.

Referring back to FIG. 1, the output processor 124 outputs entries registered in the service life management table 131 to the display device 160. Incidentally, the output processor 124 does not need to output all the items in the service life management table 131. In the first embodiment, the output processor 124 outputs such items as management No., title, creation date, and expected end of service life. The output items may be changed as required.

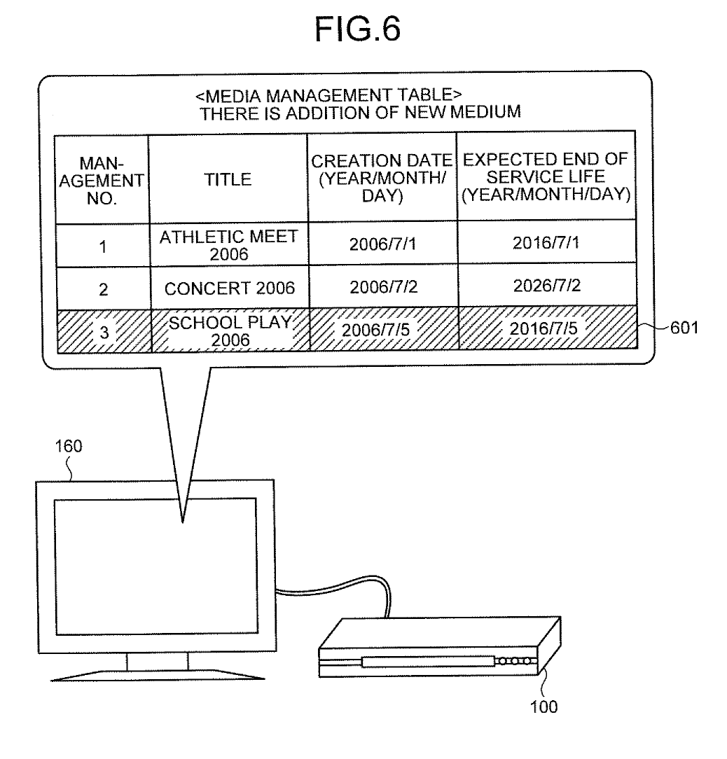

FIG. 6 illustrates an example of a screen displayed on the display device 160 based on information output form the output processor 124. As illustrated in FIG. 6, the display device 160 displays all the entries registered in the service life management table 131 in a list. In the example of FIG. 6, the screen displays the entries of the service life management table 131 illustrated in FIG. 4. The display device 160 displays the information items including management No., title, creation date, and expected end of service life on the screen. This allows the user to check the expected end of service life of each of the data storage media 150. Additionally, as illustrated in FIG. 6, a newly added entry may be displayed in a different color so that the user can recognize the new entry of a data storage medium.

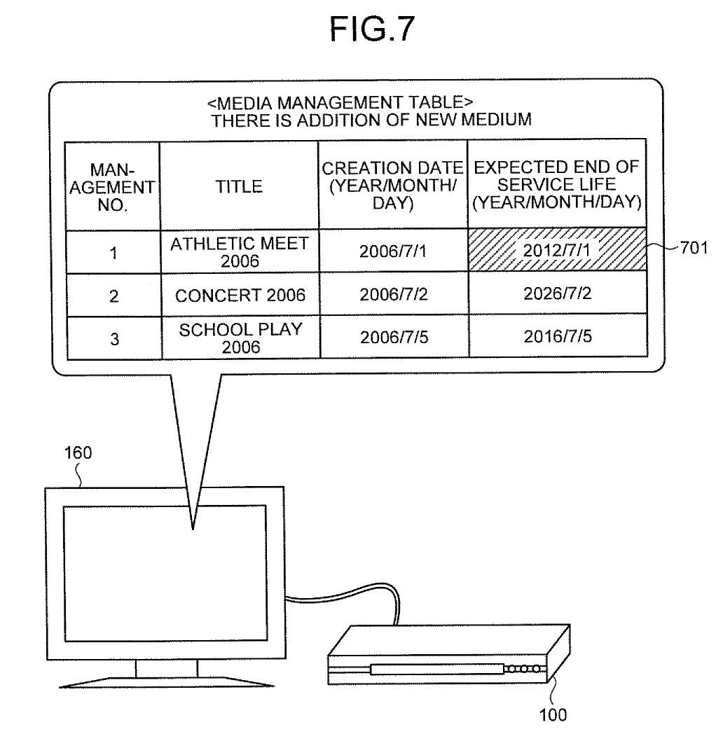

When the service life management table 131 is updated in the HDD 101, the output processor 129 outputs entries of the update service life management table 131 to the display device 160. FIG. 7 illustrates an example of a screen displayed on the display device 160 based on information output form the output processor 124 after the update module 123 updates the service life management table 131. In the example of FIG. 7, the screen displays the entries of the service life management table 131 illustrated in FIG. 5. This allows the user to check the update expected end of service life of each of the data storage media 150. Additionally, as illustrated in FIG. 7, a newly updated field (expected end of service life) may be displayed in a different color so that the user can specify a data storage medium for which the expected end of service life has been updated as well as the update expected end of service life.

Besides, the service life management table 131 is also updated when there is a change in the environmental information. Accordingly, the display device 160 displays the expected end of service life updated along with the change of the environmental information. In the following, this process will be described.

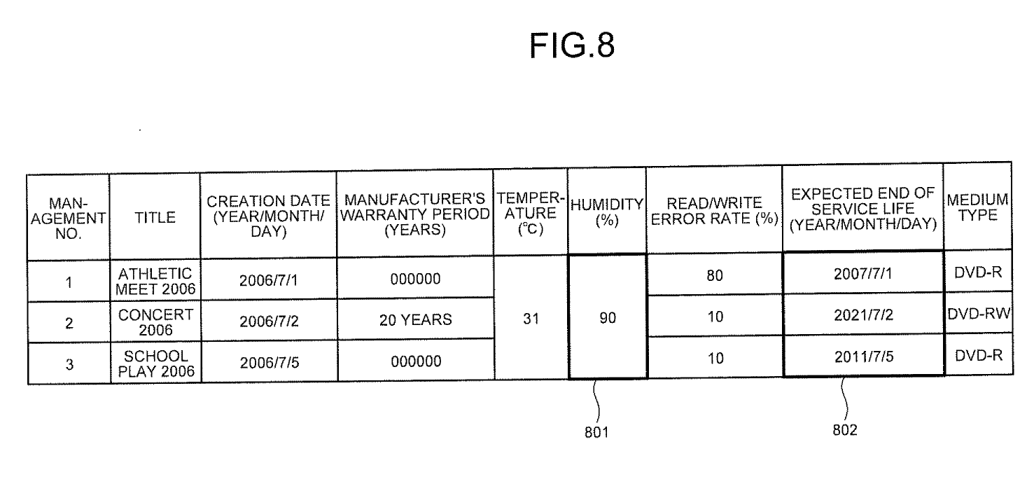

It is assumed that the environmental information acquiring module 108 acquires information, a humidity of “90%”, and notifies the CPU 102 of the humidity. In this case, the update module 123 updates the humidity in the service life management table 131 with “90%”. Since the algorithm defines “minus one year for each 5% increase in humidity from 80%”, the update module 123 subtracts two years from the expected end of service life for each entry in the service life management table 131 of FIG. 5, thereby updating the entry. FIG. 8 illustrates an example of the service life management table 131 updated by the update module 123 based on a change in humidity. In the example of FIG. 8, the update module 123 updates a field 801 with “90%”. At the same time, the update module 123 updates a field 802 with the date obtained for each entry by subtracting two years from the already-set expected end of service life as described above. The same is true in the case of temperature changes, and a further description thereof will not be necessary.

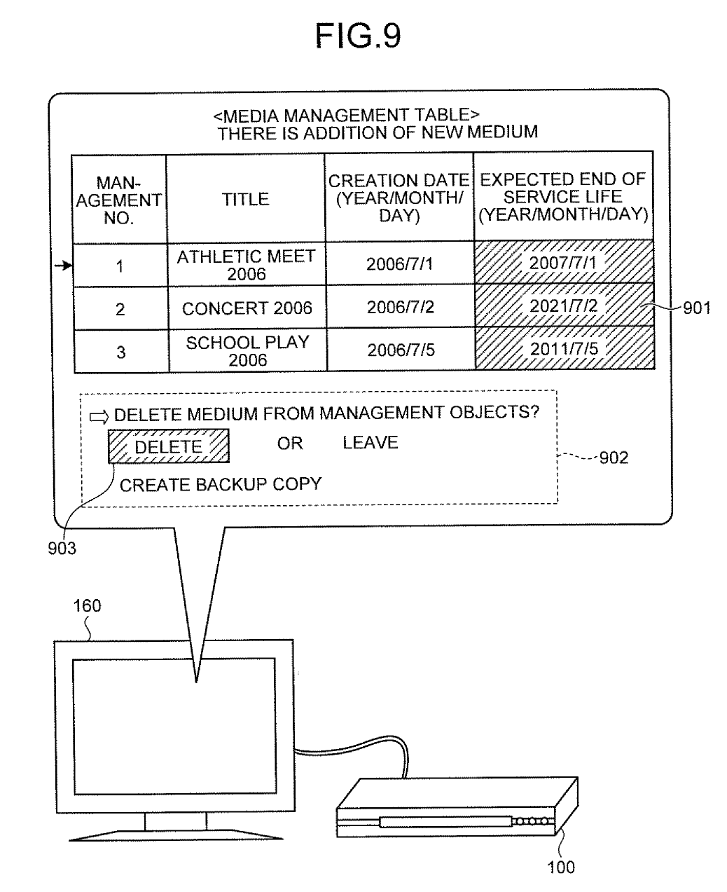

FIG. 9 illustrates an example of a screen displayed on the display device 160 based on information output form the output processor 124 after the update module 123 updates the service life management table 131 as illustrated in FIG. 8. In the example of FIG. 9, the screen displays the entries of the service life management table 131 illustrated in FIG. 8. As illustrated in FIG. 8, a newly updated field 901 (expected end of service life) may be displayed in a different color so that the user can check the update expected end of service life of the data storage media 150.

Besides, in the example of FIG. 9, with respect to the entry assigned management No. “1”, the time period from today (or the creation date) until the expected end of service life is not more than one year. In this case, the user can select a desired process for the entry with management No. “1” from a menu 902 displayed on the screen of FIG. 9. For example, if the user has taken some measures for the data storage medium 150 registered as the entry with management No. “1” or determines that there is no need of saving data stored in the data storage medium 150, he/she selects “Delete” 903 in response to an inquiry “Delete the Medium from Management Objects?”.

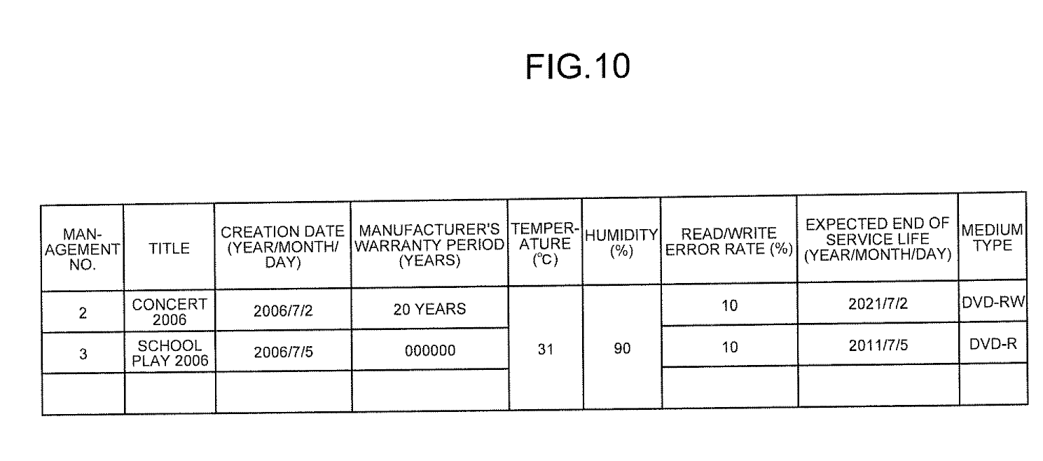

When the user selects “Delete” 903, the update module 123 deletes the entry assigned management No. “1” from the service life management table 131. FIG. 10 is a schematic diagram of the service life management table 131 after the update module 123 deletes the entry with management No. 1. As can be seen from FIG. 10, only the entries with management Nos. 2 and 3 remain in the service life management table 131.

In this manner, the user can take appropriate action on a data storage medium whose service life may be shortly coming to an end. Further, as illustrated in FIG. 9, the menu 902 displayed on the display device 160 may contain a message that encourages the user to create a backup copy of data stored in the data storage medium whose service life may be shortly coming to an end. If the user selects to make the backup copy, the information processor 100 saves or copies the data stored in the data storage medium 150 assigned management No. “1” to a new data storage medium. Several techniques have already been proposed to perform this step, and thus it will not be described herein. The data storage medium that stores the backup copy is assigned a new management number, and the process ends.

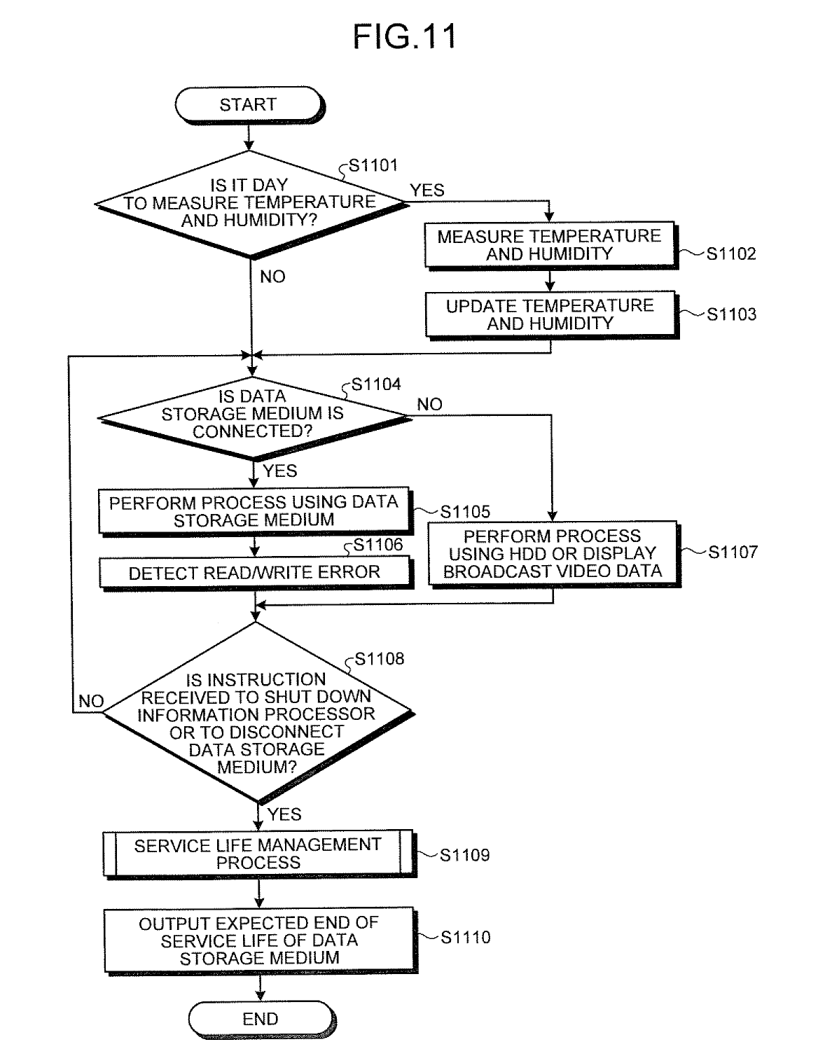

A description will now be given of the operation of the information processor 100 when activated according to the first embodiment. FIG. 11 is a flowchart of the operation of the information processor 100 according to the first embodiment.

After the information processor 100 is turned on, the environmental information acquiring module 108 determines whether it is the day and time to measure the temperature and humidity (S1101). It is assumed herein that the environmental information acquiring module 108 determines that it is the day and time to measure the temperature and humidity when the information processor 100 is turned on, and thereafter, makes a determination as to this issue periodically. The measurement may be performed at any time on any day, and here it is set to be performed, for example, at 15:00 on Monday every week.

Upon determining that it is the day and time to measure the temperature and humidity (Yes at S1101), the environmental information acquiring module 108 measures the temperature and humidity with the built-in sensor (S1102). The environmental information acquiring module 108 then notifies the CPU 102 of information on the temperature and humidity thus acquired.

The update module 123 of the CPU 102 updates the temperature and humidity in the service life management table 131 with the acquired information (S1103). If, for example, the measured temperature is “23° C.” and humidity is “60%”, the update module 123 updates the service life management table 131 with these values.

On the other hand, upon determining that it is not the day and time to measure the temperature and humidity (No at S1101), the environmental information acquiring module 108 performs no specific operation.

Next, the detector 142 of the data storage medium controller 105 detects whether any of the data storage media 150 is connected to the information processor 100 (S1104). When the detector 142 detects that any of the data storage media 150 is connected to the information processor 100 (Yes at S1104), the information processor 100 performs a process using the data storage medium 150 according to the user's operation (S1105). Examples of the process include the recording of image data on the data storage medium 150, the reproduction of the image data, and the transfer of the image data.

The term “recording” as used herein refers to the process of recording image data received by the image data receiver 106 on the data storage medium 150. The term “reproduction”, as used herein refers to the process of reproducing image data recorded on the data storage medium 150. The term “transfer” as used herein refers to the process of transferring image data stored in the HDD 101 to the data storage medium 150.

After that, the storage medium information acquiring module 141 detects a read/write error on each of the data storage media 150 (S1106). It is assumed herein that the storage medium information acquiring module 141 always performs the detection of a read/write error while the information processor 100 is performing a process using any of the data storage media 150.

On the other hand, when the detector 142 detects that none of the data storage media 150 is connected to the information processor 100 (No at S1104), the information processor 100 performs a process using the HDD 101, the process of displaying video data being broadcasted received by the image data receiver 106, or the like (S1107). Examples of the process using the HDD 101 include the recording of image data on the HDD 101 and the reproduction of image data stored in the HDD 101.

Thereafter, the CPU 102 determines whether an instruction is received from the user to shut down the information processor 100 or to disconnect the data storage medium 150 (S1108). When the CPU 102 determines that no instruction is received from the user to shut down the information processor 100 or to disconnect the data storage medium 150 (No at S1108), the process returns to S1104 and the detector 142 detects whether any of the data storage media 150 is connected to the information processor 100.

On the other hand, having determined that an instruction is received from the user to shut down the information processor 100 or to disconnect the data storage medium 150 (Yes at S1108), the CPU 102 performs a service life management process for the data storage medium 150 (S1109). The service life management process will be described in detail later.

After the service life management process for the data storage medium 150 at S1109, the output processor 124 outputs to the display device 160 the expected end of service life of each of the data storage media 150 (S1110). Thus, the display device 160 displays the expected end of service life of each of the data storage media 150 (see, for example, FIGS. 6 and 7).

In this manner, the service life management table 131 is updated based on the environmental information. Thus, it is possible to display the update expected end of service life of each of the data storage media 150. This allows the user to check the update expected end of service life of each of the data storage media 150 and take necessary measures to prevent loss of data.

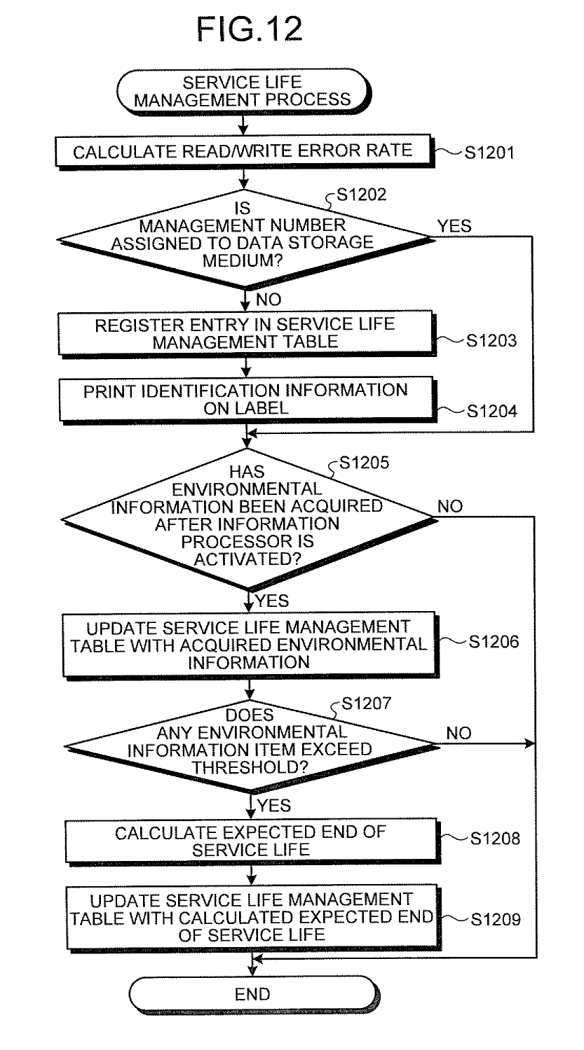

A description will then be given of the service life management process for the data storage medium 150 at S1109 in FIG. 11. FIG. 12 is a flowchart of the service life management process performed by the information processor 100 in the first embodiment.

First, the environmental information acquiring module 108 calculates the read/write error rate for the data storage medium 150 connected to the information processor 100 (S1201). More specifically, at S1106 in FIG. 11, information is retained as to the number of sectors from/to which data is read/written successfully and the number of sectors where a read/write error occurs. When an instruction is received to shut down the information processor 100 or to disconnect the data storage medium 150, the environmental information acquiring module 108 divides the number of erroneous sectors by the number of successful sectors, thereby obtaining the read/write error rate.

Then, the detector 142 determines whether a management number is assigned to the data storage medium 150 connected to the information processor 100 (S1202). The assignment of a management number can be checked based on whether a management number is written to the header of the data storage medium 150 or whether a management number is printed on the label of the data storage medium 150. If a management number is assigned to the data storage medium 150, it may be checked whether the management number is registered as an entry in the service life management table 131.

When the detector 142 determines that a management number is assigned to the data storage medium 150, no specific operation is performed.

On the other hand, when the detector 142 determines that no management number is assigned to the data storage medium 150 (No at S1202), the register 122 of the CPU 102 assigns a management number to the data storage medium 150, and makes an entry of the management number in the service life management table 131 (S1203). At this time, the register 122 also registers, with respect to the management number, information items, such as the title, the creation date, the manufacturer's warranty period, the read/write error rate calculated at S1201, the expected end of service life, and the medium type, in association with one another. Such information can be obtained by commonly known methods or the methods described above, and any further description will not be necessary.

Thereafter, the label printer 143 of the data storage medium controller 105 prints identification information that identifies the data storage medium 150 on the label thereof (S1204). In the first embodiment, the management number and the creation date are used as the identification information, and are printed on the label of the data storage medium 150 as illustrated in FIG. 3.

The CPU 102 determines whether environmental information has been acquired after the information processor 100 is turned on this time (S1205). Examples of the environmental information include temperature, humidity, and read/write error rate. If the CPU 102 determines that no environmental information has been acquired (No at S1205), the process ends.

On the other hand, if the CPU 102 determines that environmental information has been acquired (Yes at S1205), the update module 123 updates a corresponding field in the service life management table 131 with the acquired environmental information (S1206).

The update module 123 then determines whether each of acquired environmental information items exceeds a predetermined threshold (S1207). Having determined that any of the environmental information items exceeds the threshold (Yes at S1207), the update module 123 calculates update expected end of service life based on the environmental information item that exceeds the threshold (S1208). The method of calculating the expected end of service life has already been described, and the description will not be repeated.

After that, the update module 123 updates the expected end of service life with the calculated one for an entry in the service life management table 131 assigned the same management number as that assigned to the data storage medium 150 connected to the information processor 100 (S1209).

In this manner, a data storage medium that is connected first time to the information processor 100 is registered in the service life management table 131 and the service life management table 131 is updated as to, for example, the expected end of service life of the data storage media 150.

With reference to FIG. 12, a description will be given of the case where one of the data storage media 150 assigned management No. “1”, which has already been registered, is connected to the information processor 100. In the following description, it is assumed that the environmental information acquiring module 108 determines that it is not the day and time to measure the temperature and humidity at S1101 of FIG. 11 and that the storage medium information acquiring module 141 properly detects a read/write error on the data storage medium 150 assigned management No. “1” at S1106.

At S1201 in FIG. 12, the environmental information acquiring module 108 calculates the read/write error rate for the data storage medium 150 with management No. “1”. The calculated read/write error rate is, for example, “80%”.

Since a management number is already assigned to the data storage medium 150 (Yes at S1202), the CPU 102 determines whether environmental information has been acquired after the information processor 100 is turned on this time (S1205).

The read/write error rate has been obtained as the environmental information (Yes at S1205), and therefore, the update module 123 updates a corresponding field in the service life management table 131 with the obtained environmental information (S1206). That is, with respect to the entry assigned management No. “1”, the read/write error rate is updated with “80%”.

After that, the update module 123 determines whether each of acquired environmental information items exceeds a predetermined threshold (S1207). In this example, the read/write error rate is “80%”, and the threshold thereof is “40%” as described above. Thus, the update module 123 determines that the read/write error rate exceeds the threshold (Yes at S1207).

Accordingly, the update module 123 subtracts four years from the already-set expected end of service life based on the algorithm that defines “minus one year for each 10% increase in read/write error rate from 40%”. Thus, the update module 123 obtains update expected end of service life (S1208).

The update module 123 then updates the service life management table 131 with the update expected end of service life (S1209). As a result, the service life management table 131 as illustrated in FIG. 5 is obtained, and the screen as illustrated in FIG. 7 is displayed on the display device 160. In this manner, the expected end of service life can be updated properly, and the update expected end of service life can be provided to the user.

The information processor 100 is described above as being in operation during the process. However, the expected end of service life of each of the data storage media 150 is updated according to the surrounding environment even if the information processor 100 is in standby or none of the data storage media 150 is connected to the information processor 100. A description will be given of the update process performed when the information processor 100 is not in operation.

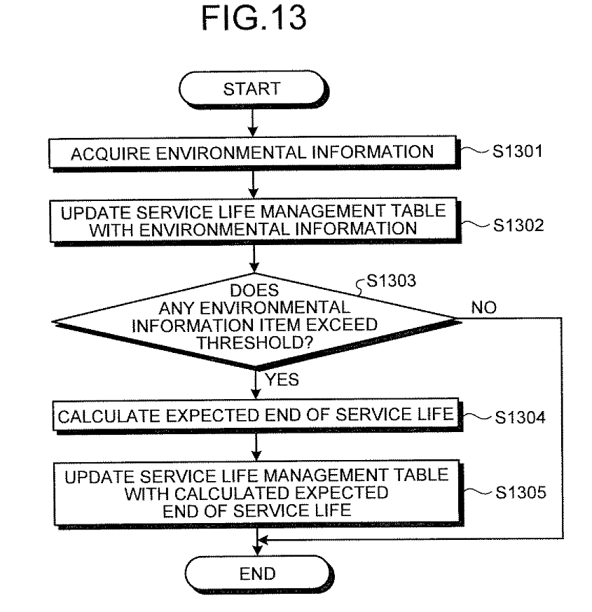

FIG. 13 is a flowchart of the above process performed by the information processor 100 according to the first embodiment. This process is performed by automatically waking up the information processor 100 once a week at a predetermined time with the built-in timer of the environmental information acquiring module 108.

First, the environmental information acquiring module 108 acquires environmental information at a predetermined time on a predetermined day of the week (S1301). At this time, the environmental information acquiring module 108 acquires, for example, temperature and humidity.

Next, the update module 123 updates the service life management table 131 with the environmental information (temperature and humidity) (S1302).

The update module 123 then determines whether each of acquired environmental information items (temperature and humidity) exceeds the threshold (S1303). When the update module 123 determines that none of the environmental information items exceed their thresholds (No at S1303), the process ends.

On the other hand, having determined that any of the environmental information items exceeds the threshold (Yes at S1303), the update module 123 calculates update expected end of service life for each entry in the service life management table 131 based on the environmental information (temperature and/or humidity) (S1304).

After that, the update module 123 updates the service life management table 131 with the update expected end of service life (S1305). Thus, the process ends.

The above process will be further explained using a specific example. In the following example, the temperature and humidity are measured at 15:00 on every Monday to update the expected end of service life.

It is assumed that the information processor 100 is in standby mode at 15:00 on Monday. Then, the information processor 100 is automatically woken up with the timer of the environmental information acquiring module 108.

The environmental information acquiring module 108 measures the temperature and humidity, and obtains the temperature “30° C.” and the humidity “85%” (S1301). With this environmental information, the update module 123 updates the service life management table 131.

The update module 123 then determines whether the temperature and the humidity exceed their thresholds, respectively (S1303). In the first embodiment, the threshold temperature is “28° C.” and the threshold humidity is “80%”, and thus the update module 123 determines that both the temperature and humidity exceeds the thresholds (Yes at S1303). Accordingly, the update module 123 calculates update expected end of service life (S1304). The algorithm to calculate the expected end of service life has already been described and therefore will not be repeated.

First, the update module 123 calculates years to subtract. More specifically, since the temperature “30° C.” is 2° C. higher than the threshold temperature “28° C.”, the update module 123 determines to subtract two years from the already-set expected end of service life. Similarly, the humidity “85%” is 5% higher than the threshold humidity “80%”, the update module 123 determines to subtract one year from the already-set expected end of service life. Thus, the update module 123 subtracts three years from the already-set expected end of service life for all the entries in the service life management table 131.

If the expected end of service life is set as, for example, “2012/7/1” for the entry with management No. 1 before update, the update module 123 updates it with “2009/7/1”. The update module 123 updates other entries in the same manner, and the process ends.

As described above, according to the first embodiment, the information processor 100 manages the expected service life of each of the data storage media 150. Thus, it is possible to output the expected service life of even the data storage media 150 that are not connected to the information processor 100. This allows the user to check the expected service life of the data storage media 150 including those not connected to the information processor 100. Therefore, data can be prevented from being lost even from the data storage media 150 that are not currently being used.

In other words, the information processor 100 manages the service life of a plurality of the data storage media 150 that are not always connected thereto. Moreover, the information processor 100 updates the expected service life of each of the data storage media 150 according to changes in the surrounding environment and deterioration depending on use frequency, thereby providing update expected service life to the user. Thus, it is possible to prevent data from being lost due to failure of the data storage media 150 along with changes in the surrounding environment.

In the first embodiment, the user is notified that there is an entry in which the time period from today or the creation date until the expected end of service life is not more than one year, and is inquired as to whether to delete the entry. However, if the user does not take appropriate measures at that point, the expected service life may have expired. A second embodiment of the invention describes the operation of the information processor 100 when the expected service life has expired. The information processor 100 of the second embodiment is of basically the same configuration and operates in the same manner as that of the first embodiment, and therefore, its description will not be repeated.

The information processor 100 of the second embodiment updates the expected end of service life for all the entries indicating the data storage media 150, respectively, as previously described in connection with FIGS. 11 and 12. With the repetition of the process and the lapse of time, the date of today (or the creation date) may reach or pass the expected end of service life. The process until this date is the same as previously described in the first embodiment, and any further description will not be necessary. The expected service life may have expired due to the update of the service life management table 131 according to any of the environmental information items, i.e., temperature, humidity, and read/write error rate. In the following example, the expected end of service life of the data storage medium 150 with management No. “1” becomes after the date of today or the creation date because of the temperature or humidity.

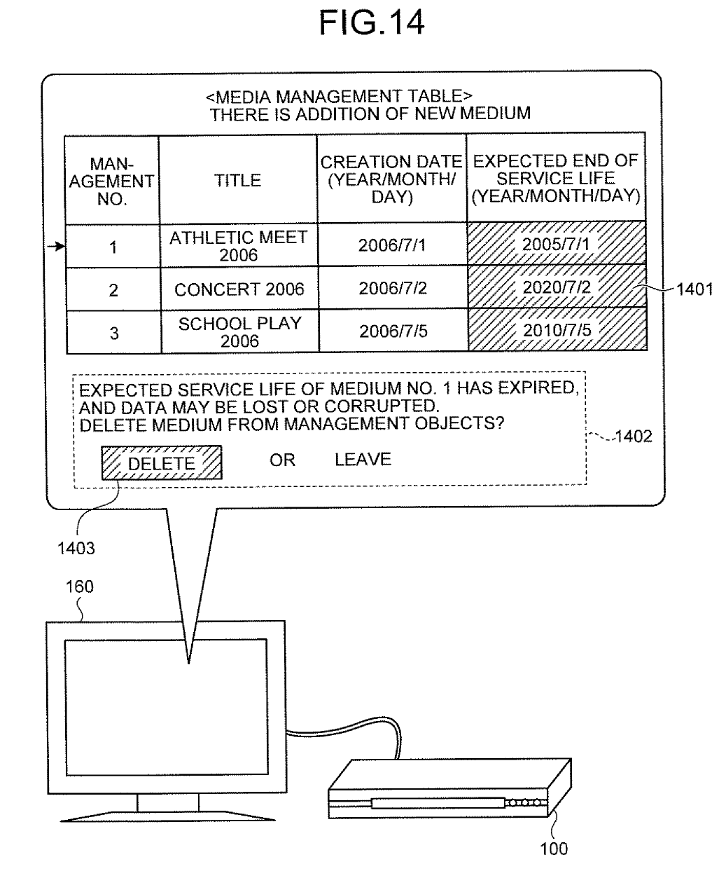

FIG. 14 illustrates an example of a screen displayed on the display device 160 based on information output form the output processor 124 in the situation described above. As illustrated in FIG. 14, a field 1401 (expected end of service life), which has been newly updated, is displayed in a different color. This allows the user to check the update expected end of service life of each of the data storage media 150.

In the example of FIG. 14, with respect to the entry with management No. “1”, the expected end of service life indicates a date previous to the creation date (or today). In this case, the user can select a desired process for the entry with management No. “1” from a menu 1402 displayed on the screen. The selectable processes may be the same as in the first embodiment, and will not described here.

As described above, according to the second embodiment, the same effect as in the first embodiment can also be achieved. In addition, even if the expected service life has expired, appropriate measures can be taken.

In the above embodiments, the information processor 100 is described as recording data on the HDD 101 or the data storage media 150 such as DVD-R and DVD-RW. However, this is by way of example and not of limitation. The information processor 100 may record data on, for example, a solid state drive (SSD) and a tape medium. In other words, the data storage media 150 may include SSD and tape media. The expected end of service life may also be set for the SSD and tape media. Besides, different environmental information items may be used to calculate the expected end of service life. Further, a different threshold may be set for each of the environmental information items.

While the environmental information acquiring module 108 is described above as obtaining temperature and humidity as the environmental information, the environmental information is not limited to them. For example, the environmental information may include anything that deteriorates the data storage media 150 such as illuminance and magnetic field.

Further, while the environmental information acquiring module 108 is described above as obtaining the environmental information using the sensor, it is not so limited. For example, the environmental information acquiring module 108 may acquire weather information for the region where the data storage media 150 are stored via the network 180 through the communication I/F 107.

Still further, the output processor 124 is described above as outputting the expected end of service life and the like to the display device 160, it is not so limited. The output processor 124 may output such information as audio or via a network. Additionally, the messages may be different from those described above and may be provided to the user at different timing. That is, any message may be used in any manner.

Still further, the method of calculating the expected end of service life is not limited to that described above in terms of time and date to measure the temperature and humidity, threshold of each environmental information item, and algorithm.

Still further, in the above embodiments, the date on which data is written to the data storage media 150 is specified as the creation date and used as a reference to calculate the expected end of service life. However, the reference date for the calculation is not limited to the creation date. For example, the expected end of service life may be calculated based on the date on which data on each of the data storage media 150 is reproduced for the first time.

Still further, while the label printer 143 is described above as printing a management number and creation date on the label of the data storage media 150, the printed information is not limited to a management number and creation date. For example, information such as title and calculated expected end of service life may be printed on the label of the data storage media 150.

As described above, according to the above embodiments, the information processor 100 can manage a plurality of data storage media regardless of whether they are always connected thereto. The information processor 100 updates the expected service life according to changes in the surrounding environment and deterioration depending on use frequency, thereby providing update expected service life to the user. This reduces the user's burden to manually check the service life of the data storage media as well as preventing data from being lost due to failure of the data storage media.

Moreover, the information processor 100 prints a management number and creation date on the label of a data storage medium upon recording data thereon. This eliminates the need for the user to manually accomplish the same task, and thereby facilitates the user's management of the data storage media.

The service life management program 111 that is executed on a computer to implement the information processor 100 may be provided as being stored in a computer-readable storage medium, such as a compact disk read-only memory (CD-ROM), a flexible disk (FD), a compact disc-recordable (CD-R), or a digital versatile disc (DVD), in an installable or executable format.

The service life management program 111 may also be stored in a computer connected via a network such as the Internet so that it can be downloaded therefrom. The service life management program 111 may also be provided or distributed via a network such as the Internet.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A medium processor comprising:
a detector configured to detect a data storage medium;
an acquiring module configured to acquire a use period that is set as a period during which data recorded on the data storage medium is supposed to be intact;
a storage module configured to store identification information that identifies the data storage medium in association with the use period; and
an output module configured to output the identification information and the use period stored in the storage module in association with each other.

2. The medium processor of claim 1, further comprising a printing module configured to print the identification information on the data storage medium.

3. The medium processor of claim 1, further comprising:
an information acquiring module configured to acquire information on surrounding environment; and
an update module configured to update the use period stored in the storage module based on the information on the surrounding environment.

4. The medium processor of claim 3, wherein the information acquiring module is configured to acquire, as the information on the surrounding environment, temperature, humidity, and a rate of occurrence of errors while the data storage medium is read or written.

5. A medium processing method comprising:
a detector detecting a data storage medium;
an acquiring module acquiring a use period that is set as a period during which data recorded on the data storage medium is supposed to be intact;
storing identification information that identifies the data storage medium in association with the use period in a storage module; and
an output module outputting the identification information and the use period stored in the storage module in association with each other.

6. The medium processing method of claim 5, further comprising a printing module printing the identification information on the data storage medium.

7. The medium processing method of claim 5, further comprising:
an information acquiring module acquiring information on surrounding environment; and
an update module updating the use period stored in the storage module based on the information on the surrounding environment.
